(19) United States
(12) Patent Application Publication
(10) Pub. No.: US 2025/0316907 A1
(43) Pub. Date: Oct. 9, 2025

(54) FEEDING APPARATUS, ANTENNA APPARATUS, AND COMMUNICATION DEVICE

(71) Applicant: HUAWEI TECHNOLOGIES CO., LTD., Shenzhen (CN)

(72) Inventors: Zhiqiang LIAO, Shenzhen (CN); Yaohui ZHANG, Shenzhen (CN); Qi ZHANG, Dongguan (CN); Zhiyong LI, Dongguan (CN)

(21) Appl. No.: 19/244,020

(22) Filed: Jun. 20, 2025

Related U.S. Application Data
(63) Continuation of application No. PCT/CN2023/134727, filed on Nov. 28, 2023.

(30) Foreign Application Priority Data
Dec. 23, 2022 (CN) 202211668996.4

(51) Int. Cl. H01Q 13/20; H01Q 3/36

(52) U.S. Cl. CPC H01Q 13/206; H01Q 3/36

(57) ABSTRACT

This application provides a feeding apparatus. The feeding apparatus includes a first cavity, a second cavity, a third cavity, and a signal line. The signal line includes a first signal line, a second signal line, and a third signal line, the first signal line is configured to connect to the first radiating element group of the antenna apparatus, and the second signal line is configured to connect to the second radiating element group of the antenna apparatus. The first signal line is located in the first cavity, the second signal line is located in the second cavity, and the third signal line is located in the third cavity. The third signal line is configured to electrically connect to the radio frequency apparatus of the communication device, and the third signal line is electrically connected to the first signal line and the second signal line separately.

### CROSS-REFERENCE TO RELATED APPLICATIONS

This application is a continuation of International Application No. PCT/CN2023/134727, filed on Nov. 28, 2023, which claims priority to Chinese Patent Application No. 202211668996.4, filed on Dec. 23, 2022. The disclosures of the aforementioned applications are hereby incorporated by reference in their entireties.

### TECHNICAL FIELD

This application relates to the field of communication technologies, and specifically, to a feeding apparatus, an antenna apparatus, and a communication device.

### BACKGROUND

With development of wireless communication technologies, signals transmitted in a communication system are increasingly diverse, leading to more complex requirements for an antenna on a base station. An antenna apparatus of the base station usually includes a radiating element and a feeding network, and the feeding network is disposed in a cavity and is configured to feed the radiating element.

In the conventional technology, the feeding network is disposed in the cavity. To reduce coupling between feed lines, a spacing is required between the feed lines, and therefore, required arrangement space is also large. Therefore, a size of the cavity is correspondingly large, and consequently, a size of the antenna is increased. This is not conducive to miniaturization of the antenna apparatus. In addition, the large size of the cavity also causes resonance interference when a signal at a high frequency is transmitted.

### SUMMARY

This application provides a feeding apparatus, an antenna apparatus, and a communication device, to help reduce a volume of the feeding apparatus, further reduce a size of the antenna apparatus, and improve integration and miniaturization of the antenna apparatus.

According to a first aspect, this application provides a feeding apparatus. The feeding apparatus is used in an antenna apparatus, and the antenna apparatus includes a first radiating element group and a second radiating element group, configured to radiate or receive a signal. The antenna apparatus may be used in a communication device, and is electrically connected to a radio frequency apparatus of the communication device, to implement feeding of the first radiating element group and the second radiating element group. Specifically, the feeding apparatus includes a first cavity, a second cavity, a third cavity, and a signal line. The signal line includes a first signal line, a second signal line, and a third signal line, the first signal line is configured to connect to the first radiating element group of the antenna apparatus, and the second signal line is configured to connect to the second radiating element group of the antenna apparatus. Specifically, the first signal line is located in the first cavity, the second signal line is located in the second cavity, and the third signal line is located in the third cavity. The third signal line is specifically configured to electrically connect to the radio frequency apparatus of the communication device, and the third signal line is electrically connected to the first signal line and the second signal line separately, so that the first radiating element group and the second radiating element group are fed through the first signal line and the second signal line respectively. The feeding apparatus includes a plurality of cavities, a small quantity of signal lines are disposed in each cavity, and a large gap is not required between signal lines in different cavities to reduce coupling. This improves isolation between the signal lines. Therefore, the signal lines do not need to be disposed in excessively large space. This helps reduce a volume of the feeding apparatus, further reduces a size of the antenna apparatus, and improves integration and miniaturization of the antenna apparatus. In addition, distributed wiring is implemented in the feeding apparatus in this application, and decoupling effect between the first signal line and the second signal line is good, to implement amplitude-phase optimization.

Specifically, when the signal lines are disposed, the first signal line has a first end, the first end is configured to connect to the first radiating element group, the second signal line has a second end, and the second end is configured to connect to the second radiating element group. A length of the signal line between the first end and a first connection point is equal to a length of the signal line between the second end and the first connection point. In this solution, lengths of signal lines between the radio frequency apparatus and different radiating elements are the same, and losses generated on transmission paths are the same, to ensure good consistency between signals transmitted by the radiating elements.

In a specific technical solution, the third signal line is connected to the radio frequency apparatus at the first connection point, the third signal line is connected to the first signal line at a second connection point, the third signal line is connected to the second signal line at a third connection point, and a length of the third signal line between the first connection point and the second connection point is greater than a length of the third signal line between the first connection point and the third connection point. In this solution, the third signal line is used to compensate for a length difference of a signal line connected to a radiating element, and no complex wire routing is required. This facilitates simplification of wiring of the feeding apparatus.

The feeding apparatus further includes a phase shift component, and the first signal line and the second signal line are separately coupled to the phase shift component. The phase shift component is configured to adjust phases of signals transmitted through the first signal line and the second signal line.

When the first cavity, the second cavity, and the third cavity are specifically disposed, the first cavity and the second cavity are arranged in a first direction, the third cavity is located on one side of the first cavity and the second cavity in a second direction, the first cavity and the second cavity extend in a third direction, and the first direction, the second direction, and the third direction are perpendicular to each other. The first cavity, the second cavity, and the third cavity are mutually fastened in a triangularly stacked structure, so that the third cavity can directly communicate with the first cavity and the second cavity separately, to connect the first signal line and the third signal line and connect the second signal line and the third signal line. This solution helps reduce a size of the feeding apparatus in the first direction.

When the signal lines are specifically disposed, the first cavity, the second cavity, and the third cavity extend in the third direction, the first signal line extends in the third direction in the first cavity, and the second signal line extends in the third direction in the second cavity. The first cavity and the second cavity have large sizes in the third direction, and the signal lines extend in the third direction. There are fewer winding parts, and this helps reduce signal coupling. Quantities of radiating elements included in the first radiating element group and the second radiating element group are not limited. The first radiating element group includes at least two radiating elements, and the second radiating element group includes at least two radiating elements. In addition, a quantity of radiating elements included in the first radiating element group may be the same as or different from a quantity of radiating elements included in the second radiating element group. This is not limited in this application, either.

The feeding apparatus may further include an input line. One end of the input line is connected to the third signal line, and the other end is configured to electrically connect to the radio frequency apparatus. The third signal line is connected to the radio frequency apparatus through the input line.

The input line may also be disposed in the first cavity, to fully use space in the first cavity and improve space utilization of the first cavity.

When the input line is specifically disposed, the input line may be located at an end portion of the first cavity. This solution can reduce coupling between the input line and the first signal line, and also facilitate output of the input line from the end portion of the first cavity to connect to the remote radio frequency apparatus. Therefore, in this embodiment, a path for connecting the input line and the radio frequency apparatus at a source end is short, to reduce a signal loss and improve signal radiation efficiency of the antenna apparatus.

The first cavity, the second cavity, and the third cavity extend in the third direction, and a length of the first cavity in the third direction is the same as a length of the second cavity in the third direction. This solution facilitates preparation and installation of the foregoing feeding apparatus, and facilitates proper use of installation space of the feeding apparatus of the antenna apparatus.

Specific structures of the first cavity, the second cavity, and the third cavity are not limited. In a technical solution, the first cavity, the second cavity, and the third cavity each are enclosed by metal walls. The metal walls can protect a signal line inside a cavity.

Specifically, the first cavity, the second cavity, and the third cavity each may be a square tube enclosed by metal walls.

A length of the third cavity in the third direction is less than the length of the first cavity in the third direction, and the length of the third cavity in the third direction is less than the length of the second cavity in the third direction. A size of the third cavity may be small. Other apparatuses or devices may be disposed in regions of the first cavity and the second cavity in which the third cavity is not disposed, to fully use space of the feeding apparatus, improve integration of the antenna apparatus, and reduce a size of the antenna apparatus.

Specifically, the first cavity, the second cavity, and the third cavity are integrally formed, for example, may be a casting structure, to facilitate simplification of an assembly process of the feeding apparatus.

In another technical solution, the first cavity and the second cavity each are enclosed by metal walls, the third cavity is air, and the third signal line is formed on outer surfaces of the first cavity and the second cavity. In this technical solution, the physical third cavity does not need to be disposed, and only the third signal line needs to be formed on the outer surfaces of the first cavity and the second cavity. The third signal line may be specifically a microstrip line, and the microstrip line does not require protection from a physical cavity and can still work normally.

According to a second aspect, this application further provides an antenna apparatus. The antenna apparatus includes the feeding apparatus according to the first aspect, and further includes the first radiating element group and the second radiating element group. The first radiating element group is connected to the first signal line, and the second radiating element group is connected to the second signal line. The antenna apparatus helps reduce a volume of the feeding apparatus, further reduces a size of the antenna apparatus, and improves integration and miniaturization of the antenna apparatus. In addition, distributed wiring is implemented in the feeding apparatus in this application, and decoupling effect between the first signal line and the second signal line is good, to implement amplitude-phase optimization.

According to a third aspect, this application further provides a communication device. The communication device includes the antenna apparatus in the second aspect, and further includes a mounting bracket and a radio frequency apparatus. The antenna apparatus is mounted on the mounting bracket, and the first radiating element group and the second radiating element of the antenna apparatus are electrically connected to the radio frequency apparatus through the phase shift apparatus separately. A volume of the antenna apparatus is small, and a large quantity of antenna apparatuses can be disposed in the communication device.

### BRIEF DESCRIPTION OF DRAWINGS

FIG. 1 is a diagram of an architecture of a communication system to which an embodiment of this application is applicable;

FIG. 2 is a diagram of a structure of a communication device according to a possible embodiment of this application;

FIG. 3 is a diagram of composition of an antenna apparatus according to a possible embodiment of this application;

FIG. 4 is a diagram of a top view structure of an antenna apparatus according to an embodiment of this application;

FIG. 5 is a diagram of a side view structure of an antenna apparatus according to an embodiment of this application;

FIG. 6 is a diagram of a structure of a feeding apparatus according to an embodiment of this application;

FIG. 7 is a diagram of connection of signal lines of an antenna apparatus according to an embodiment of this application;

FIG. 8 is another diagram of a structure of a feeding apparatus according to an embodiment of this application;

FIG. 9 is a diagram of connection of signal lines of an antenna apparatus according to an embodiment of this application; and

FIG. 10 is another diagram of connection of signal lines of an antenna apparatus according to an embodiment of this application.

Reference numerals:

| | |
|---|---|
| 1: antenna apparatus; | 11: radome; |
| 12: radiating element; | 121: first radiating element group; |
| 122: second radiating element group; | 123: feeding component; |
| 13: reflector plate; | 14: feeding network; |
| 141: calibration network; | 142: feeding apparatus; |
| 1421: first cavity; | 1422: second cavity; |
| 1423: third cavity; | 1424: first signal line; |
| m: first end; | 1425: second signal line; |
| n: second end; | 1426: third signal line; |
| a: first connection point; | b: second connection point; |
| c: third connection point; | 1427: phase shift component; |
| 1428: input line; | 143: combiner; |
| 144: filter; | 2: mounting bracket; |
| 3: antenna adjustment bracket; | 4: radio frequency processing unit; |
| 5: baseband processing unit; | 6: cable; |
| X: first direction; | Y: second direction; |
| Z: third direction. | |

### DESCRIPTION OF EMBODIMENTS

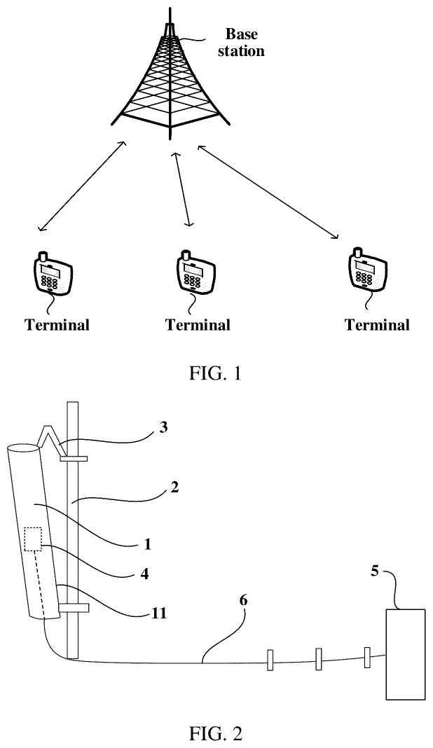

For ease of understanding of a feeding apparatus, an antenna apparatus, and a communication device provided in embodiments of this application, the following describes application scenarios of the feeding apparatus, the antenna apparatus, and the communication device. FIG. 1 is a diagram of an architecture of a communication system to which an embodiment of this application is applicable. As shown in FIG. 1, the communication system may be a base station antenna feeder system. The application scenario may include a communication device and a terminal. In this scenario, the communication device may also be referred to as a base station. Wireless communication may be implemented between the base station and the terminal. The base station may be located in a base station subsystem (BBS), a UMTS terrestrial radio access network (UTRAN), or an evolved universal terrestrial radio access network (E-UTRAN), and is configured to perform radio signal cell coverage to implement communication between the terminal device and a wireless network. Specifically, the base station may be a base transceiver station (BTS) in a global system for mobile communications (GSM) or a code division multiple access (CDMA) system, may be a NodeB (NodeB, NB) in a wideband code division multiple access (WCDMA) system, may be an evolved NodeB (eNB, or eNodeB) in a long term evolution (LTE) system, or may be a radio controller in a cloud radio access network (CRAN) scenario. Alternatively, the base station may be a relay station, an access point, a vehicle-mounted device, a wearable device, a gNodeB (gNodeB or gNB) in a new radio (NR) system, a base station in a future evolved network, or the like. This is not limited in embodiments of this application.

FIG. 2 is a diagram of a possible structure of a communication device. As a communication device, the base station may usually include structures such as an antenna apparatus 1, a mounting bracket 2, and an antenna adjustment bracket 3. The antenna apparatus 1 may include a radome 11. The radome 11 has a good electromagnetic wave penetration characteristic in terms of electrical performance, and can withstand impact of an external harsh environment in terms of mechanical performance, to protect the antenna apparatus 1 from impact of an external environment. The antenna apparatus 1 may be mounted on the mounting bracket 2 through the antenna adjustment bracket 3, to facilitate receiving or transmitting of a signal by the antenna apparatus 1. Certainly, the embodiment shown in FIG. 2 is merely used as an optional implementation. During specific implementation, the antenna apparatus and the communication device in this embodiment of this application may be different from those in the embodiment shown in FIG. 2.

In addition, the communication device may further include a radio frequency processing unit 4 and a baseband processing unit 5. For example, the radio frequency processing unit 4 may be configured to: perform frequency selection, amplification, and down-conversion processing on a signal received by the antenna apparatus 1, convert the signal into an intermediate frequency signal or a baseband signal, and send the intermediate frequency signal or the baseband signal to the baseband processing unit 5; or the radio frequency processing unit 4 is configured to perform up-conversion and amplification processing on the baseband processing unit 5 or an intermediate frequency signal, convert the baseband processing unit 5 or the intermediate frequency signal into an electromagnetic wave, and send the electromagnetic wave outwards through the antenna apparatus 1. The baseband processing unit 5 may be connected to a feeding network of the antenna apparatus 1 through the radio frequency processing unit 4. In some implementations, the radio frequency processing unit 4 may also be referred to as a remote radio unit (RRU), or may be a radio frequency apparatus in an active antenna unit (AAU). The baseband processing unit 5 may also be referred to as a baseband unit (BBU).

In a possible embodiment, as shown in FIG. 2, the radio frequency processing unit 4 and the antenna apparatus 1 may be integrally disposed, and the baseband processing unit 5 is located at a remote end of the antenna apparatus 1. In some other embodiments, both the radio frequency processing unit 4 and the baseband processing unit 5 may be located at a remote end of the antenna apparatus 1. The radio frequency processing unit 4 and the baseband processing unit 5 may be connected through a cable 6.

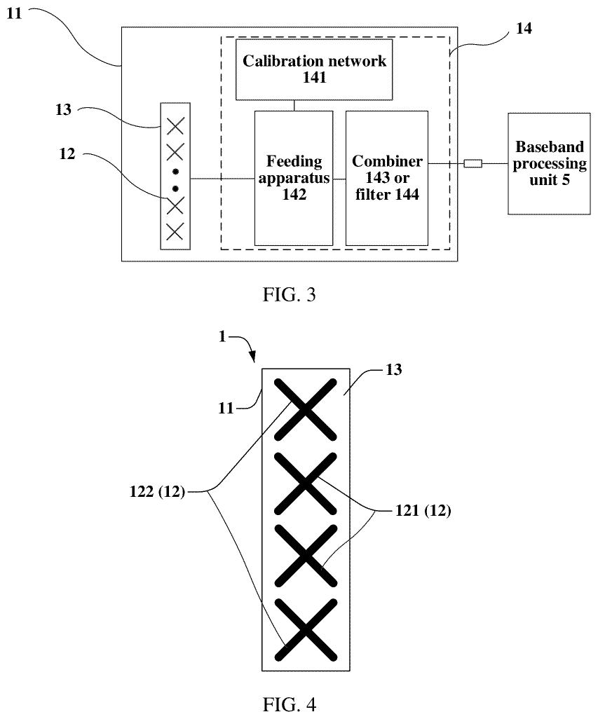

More specifically, refer to FIG. 2 and FIG. 3 together. FIG. 3 is a diagram of components of an antenna apparatus according to a possible embodiment of this application. As shown in FIG. 3, the antenna apparatus 1 of the communication device may include a radiating element 12 and a reflector plate 13. The radiating element 12 may also be referred to as an antenna element, an element, or the like, and can effectively send or receive an antenna signal. In the antenna apparatus 1, frequencies of different radiating elements 12 may be the same or different. The reflector plate 13 may also be referred to as a substrate, an antenna panel, a reflective surface, or the like, and may be made of a metal material. When the antenna apparatus 1 receives a signal, the reflector plate 13 may reflect the antenna signal to a target coverage region. When the antenna apparatus 1 transmits a signal, the reflector plate 13 may reflect and transmit a signal that is transmitted to the reflector plate 13. The radiating element 12 is usually disposed on a surface on one side of the reflector plate 13. This not only can greatly enhance a signal receiving or transmitting capability of the antenna apparatus 1, but also can block and shield interference caused to antenna signal receiving by another electromagnetic wave from a back surface of the reflector plate 13 (in this application, the back surface of the reflector plate 13 is on a side opposite to the side that is of the reflector plate 13 and that is used to dispose the radiating element 12).

In the antenna apparatus 1 of the communication device, the radiating element 12 is connected to a feeding network 14. The feeding network 14 is usually formed by a controlled impedance signal line. The feeding network 14 may feed a signal to the radiating element 12 based on a specific amplitude and a specific phase, or send a received signal to the baseband processing unit 5 of the communication device based on a specific amplitude and a specific phase. Specifically, in some implementations, the feeding network 14 may be used to implement different radiation beam directions, or may be connected to a calibration network 141 to obtain a calibration signal required by a system. The feeding network 14 may include a feeding apparatus 142, configured to change a phase of antenna signal radiation. Some modules used for performance extension may be further disposed in the feeding network 14. For example, a combiner 143 may be disposed, to combine signals of different frequencies into one signal and transmit the signal through the antenna apparatus 1; or when the combiner 143 is used reversely, the combiner 143 may be configured to divide, based on different frequencies, a signal received by the antenna apparatus 1 into a plurality of signals and transmit the signals to the baseband processing unit 5 for processing. For another example, a filter 144 may be disposed to filter out an interference signal.

It should be noted that embodiments that are related to terms such as “specific”, “specifically disposed”, and “specifically designed” in this application are all optional embodiments. In other words, this embodiment is a possible specific embodiment under the inventive concept of this application, but further includes another possible embodiment.

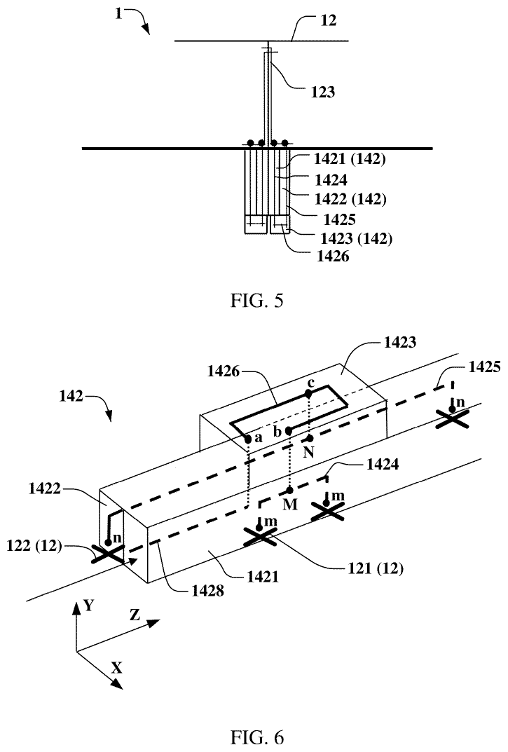

FIG. 4 is a diagram of a top view structure of an antenna apparatus according to an embodiment of this application. FIG. 5 is a diagram of a side view structure of an antenna apparatus according to an embodiment of this application. As shown in FIG. 4 and FIG. 5, radiating elements 12 of an antenna apparatus 1 in this embodiment of this application include a first radiating element group 121 and a second radiating element group 122, and the antenna apparatus 1 further includes a feeding apparatus 142. The feeding apparatus 142 includes a signal line, and the signal line is connected to the first radiating element group 121 and the second radiating element group 122. In a specific embodiment, the feeding apparatus 142 is disposed on a side that is of a reflector plate 13 and that is away from the radiating element 12. It should be noted that, in this embodiment of this application, the first radiating element group 121 and the second radiating element group 122 may be in a same structure, and may also receive same signals and send same signals. A difference lies only in: Signal lines for connecting to the feeding apparatus 142 are different. Certainly, in another embodiment, the first radiating element group 121 and the second radiating element group 122 may be in different structures, may receive different signals, and may also send different signals. This is not limited in this application.

As shown in FIG. 5, to implement an electrical connection between the radiating element 12 and the signal line of the feeding apparatus 142, the radiating element 12 of the antenna apparatus 1 includes a feeding component 123, and the feeding component 123 is connected to the feeding apparatus 142. The feeding component 123 may be specifically L-shaped, to implement a connection between the feeding component 123 and the feeding apparatus 142.

In another embodiment, the antenna apparatus 1 may further include a balun, and the balun is configured to implement grounding of the radiating element 12. Specifically, the balun may be electrically connected to the reflector plate, and the reflector plate may be electrically connected to a cavity of the feeding apparatus 142, to implement grounding of the balun.

In the embodiment shown in FIG. 5, the antenna apparatus 1 may be specifically a dual-polarized antenna. That is, the radiating element 12 may implement dual-polarized signal radiation. The dual-polarized antenna includes two feeding apparatuses 142, and each feeding apparatus 142 is configured to feed in several polarization directions. Cavities of the two feeding apparatuses 142 may be fastened to each other, or the cavities of the two feeding apparatuses 142 may be directly made into an integrated structure. This is not limited in this application.

FIG. 6 is a diagram of a structure of the feeding apparatus according to an embodiment of this application. As shown in FIG. 6, the feeding apparatus 142 in this embodiment of this application includes a first cavity 1421, a second cavity 1422, a third cavity 1423, and a signal line. The signal line is connected between a radio frequency apparatus (not shown in the figure) of a communication device and the radiating element 12 of the antenna apparatus 1, and transmits a signal between the radio frequency apparatus and the radiating element 12, to implement feeding of the radiating element 12. Specifically, a signal of the radio frequency apparatus may be sent to the radiating element 12, and is transmitted through the radiating element 12; or a signal received by the radiating element 12 may be sent to the radio frequency apparatus. The signal line specifically includes a first signal line 1424, a second signal line 1425, and a third signal line 1426. The first signal line 1424 is connected to the first radiating element group 121, the second signal line 1425 is connected to the second radiating element group 122, and the third signal line 1426 is connected to the radio frequency apparatus, and is electrically connected to the first signal line 1424 and the second signal line 1425 separately. Therefore, the radio frequency apparatus can be connected to the first radiating element group 121 and the second radiating element group 122 through the first signal line 1424 and the second signal line 1425, to feed the first radiating element group 121 and the second radiating element group 122.

In this embodiment of this application, the feeding apparatus 142 includes a plurality of cavities, a small quantity of signal lines are disposed in each cavity, and a large gap is not required between signal lines in different cavities to reduce coupling. This improves isolation. Therefore, the signal lines do not need to be disposed in excessively large space. This helps reduce a volume of the feeding apparatus 142, further reduces a size of the antenna apparatus 1, and improves integration and miniaturization of the antenna apparatus 1. In addition, distributed wiring is implemented in the feeding apparatus 142 in this embodiment of this application, and decoupling effect between the first signal line 1424 and the second signal line 1425 is good, to implement amplitude-phase optimization.

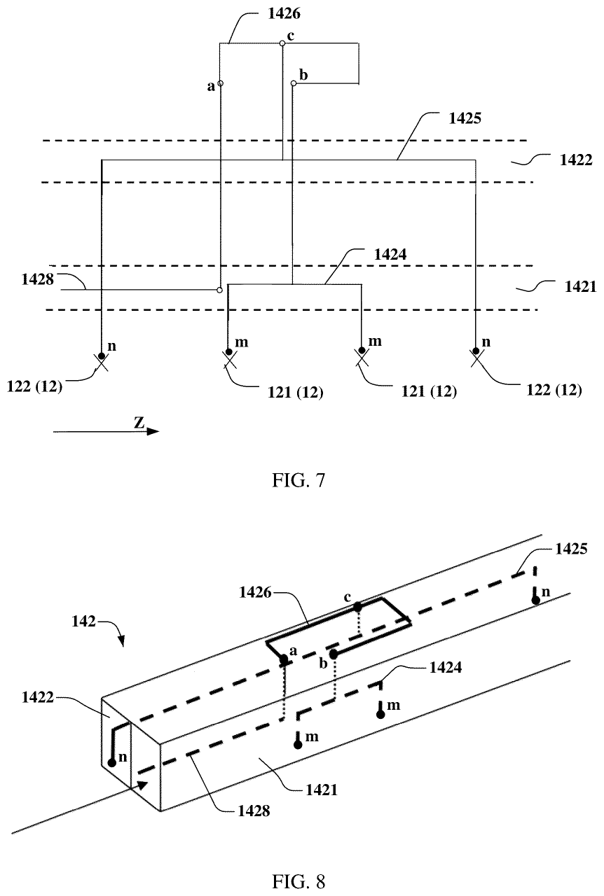

FIG. 7 is a diagram of connection of signal lines of the antenna apparatus according to an embodiment of this application. With reference to FIG. 6 and FIG. 7, the third signal line 1426 is connected to the radio frequency apparatus at a first connection point a, the first signal line 1424 has a first end m, and the first end m is connected to the first radiating element group 121. In a specific embodiment, the first signal line 1424 may be connected to the first radiating element group 121 via a connector, or may be soldered via a solder joint. The first end m may be a location of the connector or a location of the solder joint. Similarly, the second signal line 1425 has a second end n, and the second end n is connected to the second radiating element group 122. Similarly, the second signal line 1425 may be connected to the second radiating element group 122 via a connector, or may be soldered via a solder joint. The second end n may be a location of the connector or a location of the solder joint. A length of the signal line between the first end m and the first connection point a is equal to a length of the signal line between the second end n and the first connection point a. Lengths of signal lines between the radio frequency apparatus and different radiating elements 12 are the same, and losses generated on transmission paths are the same, to ensure good consistency between signals transmitted by the radiating elements 12.

In addition, because the third signal line 1426 directly implements equal transmission paths from the radio frequency apparatus to the first radiating element group 121 and the second radiating element group 122, the transmission paths from the radio frequency apparatus to the first radiating element group 121 and the second radiating element group 122 are short, and a structure is simple. This facilitates manufacturing. In addition, the transmission paths also generate a small loss. This helps improve signal radiation efficiency of the antenna apparatus 1.

It should be noted that, such limitations as “same” or “equal” in this embodiment of this application are all based on a current process level, and are not absolutely strict definitions in a mathematical sense. Equal or same sizes may have a deviation of a predetermined threshold. For example, a length difference is 3 mm, 1 mm, 0.5 m, or 0.1 mm, or the transmission paths from the radio frequency apparatus to the first radiating element group 121 and the second radiating element group 122 differ by about +5% of the transmission paths.

In a specific embodiment, to connect the third signal line 1426 and the first signal line 1424, a wall of the third cavity 1423 and a wall of the first cavity 1421 may have a first through hole, and the third signal line 1426 and the first signal line 1424 are connected via the first through hole. To connect the third signal line 1426 and the second signal line 1425, the wall of the third cavity 1423 and a wall of the second cavity 1422 may have second through holes, and the third signal line 1426 and the second signal line 1425 are connected via the second through holes. Alternatively, the third signal line 1426 may also be connected to the first signal line 1424 and the third signal line 1426 may also be connected to the second signal line 1425 via slits.

Still refer to FIG. 6 and FIG. 7. The third signal line 1426 is connected to a fourth connection point M of the first signal line 1424 at a second connection point b, and the third signal line 1426 is connected to a fifth connection point N of the second signal line 1425 at a third connection point c. A length of the first signal line 1424 between the second connection point b and the first end m (that is, a length of the first signal line 1424 between the fourth connection point M and the first end m in the figure) is less than a length of the second signal line 1425 between the third connection point c and the second end n (that is, a length of the second signal line 1425 between the fifth connection point N and the second end n in the figure), and a length of the third signal line 1426 between the first connection point a and the second connection point b is greater than a length of the third signal line 1426 between the first connection point a and the third connection point c.

In a specific embodiment, the first radiating element group 121 may include one radiating element 12, two radiating elements 12, or more radiating elements 12. This is not limited in this application. When the first radiating element group 121 includes at least two radiating elements 12, utilization efficiency of the first signal line 1424 can be improved. Similarly, the second radiating element group 122 may include one radiating element 12, two radiating elements 12, or more radiating elements 12. This is not limited in this application. When the second radiating element group 122 includes at least two radiating elements 12, utilization efficiency of the second signal line 1425 can be improved.

Because different radiating elements 12 of the antenna apparatus 1 are disposed in different locations, for example, as shown in FIG. 4 and FIG. 6, an example in which the antenna apparatus 1 includes four radiating elements 12 is used, and the four radiating elements 12 are sequentially arranged in a third direction. In the foregoing four radiating elements 12, two radiating elements 12 in the middle may be the first radiating element group 121, and two radiating elements 12 at two ends may be the second radiating element group 122. It can be learned that the first signal line 1424 and the second signal line 1425 have different distances to the third signal line 1426 in the radiating element 12. In particular, in this application, an example in which the third cavity 1423 is located in the middle of the feeding apparatus 142 in the third direction is used. The third signal line 1426 is closer to the first radiating element group 121, and is farther from the second radiating element group 122, so that the length of the first signal line 1424 between the second connection point b and the first end m is less than the length of the second signal line 1425 between the third connection point c and the second end n. In this solution, the third signal line 1426 located in the third cavity 1423 may be used to compensate for the length difference. In the structure, a solution of compensating for the foregoing length difference can be simplified, and a wire routing length can be reduced.

Specifically, when the third signal line 1426 is disposed in the third cavity 1423, the third signal line 1426 may be arranged in a form of a block, so that the third signal line 1426 is not arranged too densely, to reduce signal crosstalk.

In addition, refer to FIG. 6. In a specific embodiment, the first cavity 1421, the second cavity 1422, and the third cavity 1423 extend in the third direction Z. In other words, a size of the first cavity 1421 in the third direction Z is greater than sizes of the first cavity 1421 in a first direction X and a second direction Y, and a size of the second cavity 1422 in the third direction Z is greater than sizes of the second cavity 1422 in the first direction X and the second direction Y, a size of the third cavity 1423 in the third direction Z is greater than sizes of the third cavity 1423 in the first direction X and the second direction Y. A length of the third cavity 1423 in the third direction Z is less than a length of the first cavity 1421 in the third direction Z, and the length of the third cavity 1423 in the third direction Z is less than a length of the second cavity 1422 in the third direction Z.

In a specific embodiment, the first cavity 1421 and the second cavity 1422 each are enclosed by metal walls. For example, to simplify a structure of the feeding apparatus 142, the metal walls may form square tubes, and the first signal line 1424 and the second signal line 1425 are disposed in the first cavity 1421 and the second cavity 1422.

When the first cavity 1421 and the second cavity 1422 are specifically formed, the length of the first cavity 1421 in the third direction Z may be the same as the length of the second cavity 1422 in the third direction Z. This facilitates preparation and installation of the feeding apparatus 142, and facilitates proper use of installation space of the feeding apparatus 142 of the antenna apparatus 1.

A specific forming manner of the third cavity 1423 is not limited. For example, the third cavity 1423 may also be enclosed by metal walls, for example, is a square tube enclosed by metal walls. In this case, the third cavity 1423 may protect the third signal line 1426, and helps to shield a signal.

In this embodiment, the first signal line 1424, the second signal line 1425, and the third signal line 1426 each may be a strip line, to reduce a signal loss and improve signal radiation efficiency of the antenna apparatus 1.

In this case, because the third cavity 1423 is configured to accommodate the third signal line 1426, and the third signal line 1426 is configured to transit between the radio frequency apparatus and the first signal line 1424 and the second signal line 1425, has a small size, and also requires small arrangement space, a size of the third cavity 1423 may be small. Other apparatuses or devices may be disposed in regions of the first cavity 1421 and the second cavity 1422 in which the third cavity 1423 is not disposed, to fully use space of the feeding apparatus 142, improve integration of the antenna apparatus 1, and reduce a size of the antenna apparatus 1.

Specifically, when the feeding apparatus 142 is prepared, the first cavity 1421, the second cavity 1422, and the third cavity 1423 may be integrally formed, for example, may be a casting structure. Alternatively, the first cavity 1421, the second cavity 1422, and the third cavity 1423 may be fastened by soldering, screw connection, or the like. This is not limited in this application.

FIG. 8 is another diagram of a structure of the feeding apparatus according to an embodiment of this application. In another embodiment, the third cavity 1423 may alternatively be air, and the third signal line 1426 is formed on outer surfaces of the first cavity 1421 and the second cavity 1422. Specifically, in this embodiment, the physical third cavity 1423 does not need to be disposed, and only the third signal line 1426 needs to be formed on the outer surfaces of the first cavity 1421 and the second cavity 1422. This solution can further reduce a volume of the feeding apparatus 142, and a size of the antenna apparatus 1. In this solution, it is difficult to consider a size of the third cavity 1423. However, the third signal line 1426 occupies small space, and only a part of a region (for example, middle regions of the first cavity 1421 and the second cavity 1422 in the third direction Z) of the first cavity 1421 and the second cavity 1422 needs to be occupied in the third direction Z. Remaining regions may still be used to dispose other apparatuses or devices, to fully use space of the feeding apparatus 142 and improve integration of the antenna apparatus 1.

In this embodiment, the first signal line 1424 and the second signal line 1425 each may be a strip line, and the third signal line 1426 may be a microstrip line. The microstrip line does not require protection from a physical cavity and can still work normally.

The first cavity 1421, the second cavity 1422, and the third cavity 1423 extend in the third direction Z. When the signal lines are disposed, the first signal line 1424 extends in the third direction Z in the first cavity 1421, and the second signal line 1425 extends in the third direction Z in the second cavity 1422. The first cavity 1421 and the second cavity 1422 extend in the third direction Z, and sizes of the first cavity 1421 and the second cavity 1422 in the third direction Z are large. The signal lines extend in the third direction Z, and there are a few winding parts. This helps reduce signal coupling.

In a specific embodiment, only one signal line, namely, the first signal line 1424, may be disposed in the first cavity 1421, and only one signal line, namely, the second signal line 1425, may be disposed in the second cavity 1422. In this way, coupling between signals can be greatly weakened. Certainly, two or more signal lines may also be disposed in the first cavity 1421, and two or more signal lines may also be disposed in the second cavity 1422. For example, when the antenna apparatus 1 includes a large quantity of radiating elements 12, a large quantity of signal lines need to be disposed. However, compared with those in a scenario in which the antenna apparatus 1 includes a large quantity of radiating elements 12 in the conventional technology, coupling between adjacent signal lines can also be reduced, and volumes of the feeding apparatus 142 and the antenna apparatus 1 can be reduced.

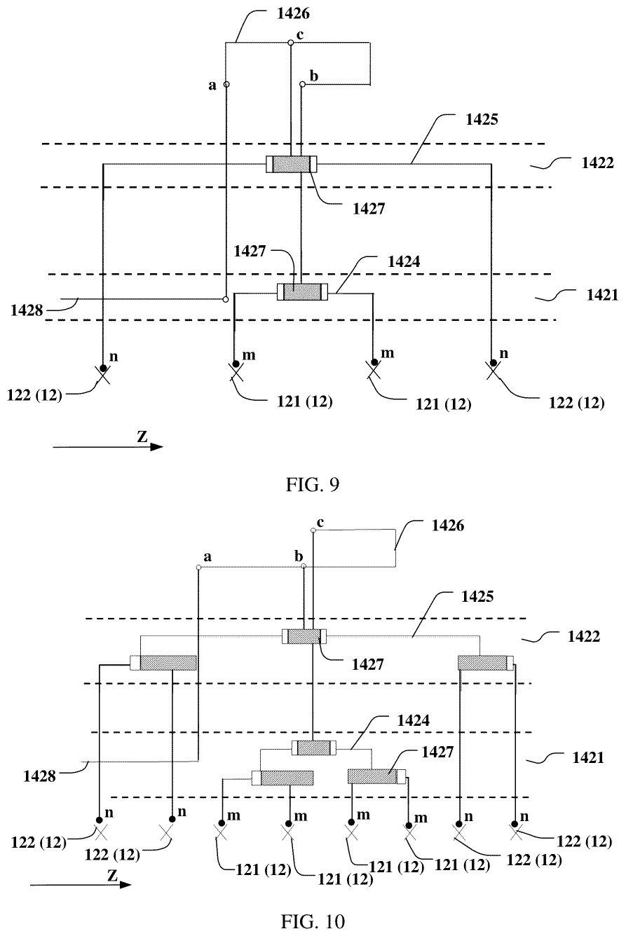

FIG. 9 is a diagram of connection of signal lines of an antenna apparatus according to an embodiment of this application. As shown in FIG. 9, in another embodiment, the feeding apparatus 142 may further include a phase shift component 1427. The first signal line 1424 and the second signal line 1425 are separately coupled to the phase shift component 1427. The phase shift component 1427 is configured to adjust phases of signals transmitted through the first signal line 1424 and the second signal line 1425. In a specific embodiment, a specific structure of the phase shift component 1427 is not limited. For example, the phase shift component 1427 may include a sliding dielectric. A phase of a signal output to the radiating element 12 is adjusted by driving the sliding dielectric to move, a phase shift function of the antenna apparatus can be implemented, and a beam direction can be changed.

Specifically, when the feeding apparatus 142 is disposed, the first cavity 1421, the second cavity 1422, and the third cavity 1423 are fastened to each other, to serve as a whole structure. The first cavity 1421 and the second cavity 1422 may be arranged in the first direction X, and the third cavity 1423 is located on one side of the first cavity 1421 and the second cavity 1422 in the second direction Y. The first direction X is perpendicular to the second direction Y. It may be considered that the first cavity 1421, the second cavity 1422, and the third cavity 1423 are fastened in a triangularly stacked structure. In other words, a width of the third cavity 1423 in the first direction X is less than a sum of widths of the first cavity 1421 and the second cavity 1422 in the first direction X, and the third cavity 1423 is located in a region between the first cavity 1421 and the second cavity 1422, so that the third cavity 1423 can be directly communicate with the first cavity 1421 and the second cavity 1422, to connect the first signal line 1424 and the third signal line 1426 and connect the second signal line 1425 and the third signal line 1426. This solution helps reduce a size of the feeding apparatus 142 in the first direction X.

Alternatively, in another embodiment, the width of the third cavity 1423 in the first direction X may be equal to or close to the sum of the widths of the first cavity 1421 and the second cavity 1422 in the first direction X. In other words, the third cavity 1423 covers surfaces of the first cavity 1421 and the second cavity 1422, so that the third signal line 1426 is separately connected to the first signal line 1424 and the second signal line 1425. This solution also helps reduce the size of the feeding apparatus 142 in the first direction X.

In still another embodiment, the first cavity 1421, the third cavity 1423, and the second cavity 1422 may also be sequentially arranged in the first direction X, and the third cavity 1423 is located between the first cavity 1421 and the second cavity 1422, so that the third signal line 1426 is separately connected to the first signal line 1424 and the second signal line 1425. This solution helps reduce a size of the feeding apparatus 142 in the second direction Y.

Refer to FIG. 6 to FIG. 9. To connect the third signal line 1426 to the radio frequency apparatus, the feeding apparatus 142 in this embodiment of this application may further include an input line 1428. One end of the input line 1428 is connected to the third signal line 1426, and the other end is configured to electrically connect to the radio frequency apparatus. The third signal line 1426 is connected to the radio frequency apparatus through the input line 1428. The input line 1428 is also disposed in the first cavity 1421, to fully use space in the first cavity 1421 and improve space utilization of the first cavity 1421.

In a specific embodiment, when the first signal line 1424 is connected to a middle first radiating element group 121, the first signal line 1424 is located in the middle of the first cavity 1421, and portions at two ends of the first cavity 1421 is not used. In this embodiment of this application, the input line 1428 is disposed in the first cavity 1421, and may be specifically disposed at an end portion of the first cavity 1421. This solution can reduce coupling between the input line 1428 and the first signal line 1424, and also facilitate output of the input line 1428 from the end portion of the first cavity 1421 to connect to the remote radio frequency apparatus. Therefore, in this embodiment, a path for connecting the input line 1428 and the radio frequency apparatus at a source end is short, to reduce a signal loss and improve signal radiation efficiency of the antenna apparatus.

In the foregoing embodiment, an example in which the first radiating element group 121 includes two radiating elements 12, and the second radiating element group 122 also includes two radiating elements 12 is used to describe the technical solutions of this application. FIG. 10 is another diagram of connection of signal lines of an antenna apparatus according to an embodiment of this application. As shown in FIG. 10, in another embodiment of this application, the antenna apparatus may alternatively include more radiating elements 12. For example, in FIG. 10, an example in which the antenna apparatus includes eight radiating elements 12 is used. The first radiating element group 121 may include four radiating elements 12, and the second radiating element group 122 may also include four radiating elements 12. Specifically, in the eight radiating elements 12, four radiating elements 12 in the middle are the first radiating element group 121, and four radiating elements 12 at two ends are the second radiating element group 122. In this embodiment, the first cavity 1421 may include two layers of first signal lines 1424, so that each layer of first signal line 1424 is connected to two radiating elements 12. Similarly, the second cavity 1422 may include two layers of second signal lines 1425, so that each layer of second signal line 1425 is connected to two radiating element groups. This solution can still reduce coupling between signal lines, so that the size of the feeding apparatus 142 in the second direction Y is small.

It is clear that a person skilled in the art can make various modifications and variations to this application without departing from the scope of this application. This application is intended to cover these modifications and variations of this application provided that they fall within the scope of protection defined by the following claims and their equivalent technologies.

1. A feeding apparatus, comprising a first cavity, a second cavity, a third cavity, and a signal line, wherein the signal line comprises a first signal line, a second signal line, and a third signal line, the first signal line is configured to connect to a first radiating element group of the antenna apparatus, and the second signal line is configured to connect to a second radiating element group of the antenna apparatus; and
the first signal line is located in the first cavity, the second signal line is located in the second cavity, the third signal line is located in the third cavity, the third signal line is configured to electrically connect to a radio frequency apparatus of the communication device, and the third signal line is electrically connected to the first signal line and the second signal line separately.

2. The feeding apparatus according to claim 1, wherein the first signal line has a first end, the first end is configured to connect to the first radiating element group, the second signal line has a second end, the second end is configured to connect to the second radiating element group, and a length of the signal line between the first end and a first connection point is equal to a length of the signal line between the second end and the first connection point.

3. The feeding apparatus according to claim 2, wherein the third signal line is connected to the radio frequency apparatus at the first connection point, the third signal line is connected to the first signal line at a second connection point, the third signal line is connected to the second signal line at a third connection point, and a length of the third signal line between the first connection point and the second connection point is greater than a length of the third signal line between the first connection point and the third connection point.

4. The feeding apparatus according to claim 1, further comprising a phase shift component, wherein the first signal line and the second signal line are separately coupled to the phase shift component.

5. The feeding apparatus according to claim 1, wherein the first cavity and the second cavity are arranged in a first direction, the third cavity is located on one side of the first cavity and the second cavity in a second direction, the first cavity and the second cavity extend in a third direction, and the first direction, the second direction, and the third direction are perpendicular to each other.

6. The feeding apparatus according to claim 1, wherein the first cavity, the second cavity, and the third cavity extend in the third direction, the first signal line extends in the third direction in the first cavity, and the second signal line extends in the third direction in the second cavity.

7. The feeding apparatus according to claim 1, wherein the first radiating element group comprises at least two radiating elements, and the second radiating element group comprises at least two radiating elements.

8. The feeding apparatus according to claim 1, further comprising an input line, wherein one end of the input line is connected to the third signal line, and the other end is configured to electrically connect to the radio frequency apparatus.

9. The feeding apparatus according to claim 8, wherein the input line is located at an end portion of the first cavity.

10. The feeding apparatus according to claim 1, wherein the first cavity, the second cavity, and the third cavity extend in the third direction, and a length of the first cavity in the third direction is the same as a length of the second cavity in the third direction.

11. The feeding apparatus according to claim 10, wherein the first cavity, the second cavity, and the third cavity each are enclosed by metal walls.

12. The feeding apparatus according to claim 11, wherein a length of the third cavity in the third direction is less than the length of the first cavity in the third direction, and the length of the third cavity in the third direction is less than the length of the second cavity in the third direction.

13. The feeding apparatus according to claim 1, wherein the first cavity, the second cavity, and the third cavity are integrally formed.

14. The feeding apparatus according to claim 1, wherein the first cavity and the second cavity each are enclosed by metal walls, the third cavity is air, and the third signal line is formed on outer surfaces of the first cavity and the second cavity.

15. An antenna apparatus, comprising a feeding apparatus, a first radiating element group and a second radiating element group, wherein the first radiating element group is connected to the first signal line, and the second radiating element group is connected to the second signal line;
wherein the feeding apparatus comprises a first cavity, a second cavity, a third cavity, and a signal line, wherein the signal line comprises a first signal line, a second signal line, and a third signal line, the first signal line is configured to connect to a first radiating element group of the antenna apparatus, and the second signal line is configured to connect to a second radiating element group of the antenna apparatus; and
the first signal line is located in the first cavity, the second signal line is located in the second cavity, the third signal line is located in the third cavity, the third signal line is configured to electrically connect to a radio frequency apparatus of the communication device, and the third signal line is electrically connected to the first signal line and the second signal line separately.

16. The feeding apparatus according to claim 15, wherein the first signal line has a first end, the first end is configured to connect to the first radiating element group, the second signal line has a second end, the second end is configured to connect to the second radiating element group, and a length of the signal line between the first end and a first connection point is equal to a length of the signal line between the second end and the first connection point.

17. The feeding apparatus according to claim 16, wherein the third signal line is connected to the radio frequency apparatus at the first connection point, the third signal line is connected to the first signal line at a second connection point, the third signal line is connected to the second signal line at a third connection point, and a length of the third signal line between the first connection point and the second connection point is greater than a length of the third signal line between the first connection point and the third connection point.

18. The feeding apparatus according to claim 15, further comprising a phase shift component, wherein the first signal line and the second signal line are separately coupled to the phase shift component.

19. The feeding apparatus according to claim 15, wherein the first cavity and the second cavity are arranged in a first direction, the third cavity is located on one side of the first cavity and the second cavity in a second direction, the first cavity and the second cavity extend in a third direction, and the first direction, the second direction, and the third direction are perpendicular to each other.

20. The feeding apparatus according to claim 15, wherein the first cavity, the second cavity, and the third cavity extend in the third direction, the first signal line extends in the third direction in the first cavity, and the second signal line extends in the third direction in the second cavity.
